(19) United States
(12) Patent Application Publication
(10) Pub. No.: US 2009/0263586 A1
(43) Pub. Date: Oct. 22, 2009

(54) Method of Producing a Self-Cleaning Surface

(76) Inventors: Stefan Goedicke, Wiebelskirchen (DE); Frank Gross, Saarlouis (DE); Stefan Sepeur, Wadgassen (DE)

Correspondence Address: COLLARD & ROE, P.C., 1077 NORTHERN BOULEVARD, ROSLYN, NY, 11576, US

(21) Appl. No.: 12/227,366

(22) PCT Filed: May 7, 2007
(86) PCT No.: PCT/DE2007/000814

§ 371 Date: Nov. 24, 2008

(30) Foreign Application Priority Data
May 17, 2006 (DE) 10 2006 023 375.1

(51) Int. Cl. B05D 3/00; B32B 17/10; B32B 27/06; B32B 27/08

(52) U.S. Cl. 427/385.5; 428/429; 428/447

(57) ABSTRACT

The invention relates to a method of producing a self-cleaning surface on a substrate.

To provide a method according to the preamble, with which surfaces can be produced which are self-cleaning indoors as well and even in the dark, it is suggested according to the invention that a coating with hydrophilic surface components be applied to the substrate and a structure formed in the nanometer range or a combined structure in the nano- and micrometer ranges.

The invention surprisingly demonstrates that the principles underlying the Lotus effect® apply not only to hydrophobic but also hydrophilic surfaces.

The invention relates to a method of producing a self-cleaning surface on a substrate.

The EP 0 772 514 A1 and the DE 199 58 321 A1 describe structured hydrophobic surfaces with self-cleaning properties (Lotus effect®). In practice, however, such surfaces are destroyed with time by environmental influences, abrasion, pollen ingress, oil and grease, etc.

Photocatalytic surfaces exist, too, which mostly work on the basis of titanium oxide. Such surfaces are known, for example, from the following publications: DE 101 05 843 A1, EP 0 850 204 B1, EP 1 132 351 B1, EP 1 608 793 A1, EP 0 944 557 B1, WO 97/23572 A, WO 98/03607 A and WO 99/41322 A. In combination with UV radiation and water or moisture, hydrophilic, i.e. water-spreading, surfaces are formed, on which dirt is infiltrated by the water or moisture film and is removed or washed off. However, UV radiation and moisture are needed to uphold this “photocatalytic effect”, i.e. to maintain a permanently hydrophilic surface. Titanium dioxides with an anatase crystal structure are energized by UV at around 380 nm, which explains why this effect only works for outdoor applications. For indoor applications it would be necessary to develop specialty titanium-dioxide modifications which are also effective behind window glass, i.e. which absorb and are energized with high quantum efficiency at wavelengths >410 nm. But even these modifications will certainly not be effective in the dark.

The object of this invention is thus to provide a method according to the preamble, with which surfaces can be produced which are self-cleaning indoors as well and even in the dark.

This object is established according to the invention by applying a coating with hydrophilic surface components to the substrate and forming a structure in the nanometer range or a combined structure in the nano- and micrometer ranges.

The invention surprisingly demonstrates that the principles underlying the Lotus effect® apply not only to hydrophobic but also hydrophilic surfaces.

One embodiment of the invention consists in that the hydrophilic surface components are silanol, carbinol or metal hydroxide groups.

It is within the scope of the invention for a structure to be formed in the nanometer range with a size from 5 to 150 nm, preferably from 5 to 80 nm.

It is also within the scope of the invention for a structure to be produced in the micrometer range with a size from 0.2 to 50 μm, preferably from 1 to 10 μm.

Production of a layer having hydrophilic surface components such as silanol, carbinol or metal hydroxide groups generally (Si—OH, C—OH, M—OH, . . . )
with glass properties and/or polymer properties
and formation of a nanostructure or a combined structure in the nanometer range (5 to 150 nm, preferably 5 to 80 nm) and the micrometer range (0.2 to 50 μm, preferably 1 to 10 μm)
   does not poison the surface. A self-cleaning effect is obtained, i.e. a permanently hydrophilic surface in the outer region, even without the use of photocatalytically active titanium dioxide compounds or of alternative photocatalytically active oxides (tin oxide, zinc oxide, . . . ).

A useful development of the invention consists in that the coating contains structure-imparting nanoparticles.

Provision may be made for the nanoparticles to be silicon dioxide particles or titanium dioxide particles.

It is also expedient that the coating contains nanoparticles of silver or silver oxide.

The scope of the invention furthermore provides for a coating material to be applied on top of a paint or coating that is not yet entirely dry.

It is within the scope of the invention to coat substrates of glass, ceramics, glass ceramics, stone, concrete, plaster, natural stone, wood, fabric, textile materials, leather, artificial leather, plastics, metals, metalloids and substrates with coated surfaces.

The invention is described below by reference to embodiments.

### EXAMPLE 1

20.8 g tetraethoxysilane (TEOS) are stirred with 10 g 0.01 N hydrochloric acid for one hour. The reaction mixture is then diluted with 500.0 g DI water, and 80.0 g Levasil 200S silica sol (H.C. Starck) are added with stirring.

### EXAMPLE 2

30 g Aerosil 300 (Degussa) are introduced into 500 g ethanol and dispersed with a Turrax disperser at 11,000 r.p.m. for 10 minutes. 17.8 g tetraethoxysilane (TEOS) are stirred with 10 g 0.01 N hydrochloric acid for one hour. The clear solution is slowly stirred into the aforementioned dispersion.

### EXAMPLE 3

20.8 g tetraethoxysilane (TEOS) and 2.0 g Dynasylan 4140 (polyethersilane from Degussa) are stirred with 10 g 0.01 N hydrochloric acid for one hour. The reaction mixture is then diluted with 500.0 g DI water, and 80.0 g Levasil 200S silica sol (H.C. Starck) are added with stirring. The solution is stirred at room temperature for a further 30 minutes.

If the coating materials from Examples 1 to 3 are applied to inorganic substrates such as glass, ceramics, mineral substrates (plaster, concrete, granite, sandstone, . . . ) or to polymeric substrates (PVC, paint, polyester, polycarbonate, . . . ) and dried (room temperature up to 500° C., depending on the maximum long-term service temperature of the substrate), one obtains a surface which shows less dirt pick-up under outdoor weathering conditions than the uncoated reference object.

The coating systems may either be applied retroactively (D.I.Y., drying at room temperature) or during the industrial manufacturing process.

If the solution from Example 1 is applied on top of a freshly cleaned car paint and left to dry for one hour at room temperature, one obtains a fine protective film. Unlike conventional car polishes, this is not strongly water-repellent (beading effect, formation of large drops), but causes the water to spread very easily (formation of a water film). It is found that environmental, traffic and industrial pollutants are washed off efficiently by (rain)water and moisture (dew) thanks to this water-spreading effect, which is familiar from surfactant-containing cleaning agents. The microstructure or combined micro-/nanostructure supports infiltration and removal of the dirt by the water film.

A roof tile spray-coated with a solution from Example 1 and dried at room temperature is also less susceptible to dirt pick-up under outdoor weathering conditions.

A PVC panel coated in the same way picks up less dirt than the uncoated reference panel.

It has been found that food residues such as ketchup, mustard, milk, etc. can be cleaned off kitchen tiles coated according to the invention more easily than is the case with conventional (uncoated) kitchen tiles.

Surprisingly, it has also been found self-cleaning properties can be conferred on conventional paints and coatings during their application without the need to modify the paint or use additional “self-cleaning additives”.

In this case the coating solution to be patented is applied in a “wet-on-wet” process.

This method involves first applying a color-imparting coating agent, e.g. paint, to the substrate. The above-described “hydrophilic coating layer” to be patented (Examples 1 to 3) is applied on top of this paint coating, either immediately or after a short flash-off period.

The wet-on-wet process can be implemented, for example, by way of two sequential operations or by combining a roller- or knife-application with a spraying operation. This procedure largely prevents the two protective films from intermixing, and ensures that the functional groups (OH groups, see above) necessary for the self-cleaning properties are preferably concentrated at the air interface. The properties of the paint substrate (adhesion, abrasion-resistance, flexibility, . . . ) remain unchanged, and the functional, i.e. active, self-cleaning groups are positioned at the surface (of the paint).

Following the wet-on-wet application, the multilayer film hardens or cures at the temperatures normally used for the paint substrate without the self-cleaning layer. The drying temperatures are between room temperature and 250° C., preferably between room temperature and 180° C., and even more preferably between 60° C. and 180° C.

The coating material may be used, for example, on the following products:

Heating and refrigeration:

Cooling units, air-conditioning equipment, heat exchangers

Automotive applications:

Radiator, air-conditioning unit, vehicle paint, vehicle-wheel rims, vehicle mirrors, vehicle glazing, bumper, truck tarpaulins

Infrastructure:

Traffic signs, traffic mirrors, crash barriers, noise barriers, billboards, posters, nameplates, junction boxes (electricity, telephone, . . . )

Components:

Window glass, window profiles, sun louvres, awnings, roller blinds, shades, facade profile elements of stainless steel, aluminum, coated substrate; facade panels (of concrete, Eternit, . . . ), floor panels, bricks, bridges, lamellae, facades, etc.

Household/garden:

Garden furniture, gardening equipment, garden dwarves, window panes and window frames, tiles (kitchen and bathroom tiles), worktops, kitchen sinks, wash basins, floor coverings (linoleum, plastic, stone, . . . )

Miscellaneous:

Gravestones, playground equipment, swimming pools, tents, solar collectors and cells, wind power plants, airplanes, motorcycles, bicycles, sensors

1. Method of producing a self-cleaning surface on a substrate, wherein a coating with hydrophilic surface components is applied to the substrate and a structure is formed in the nanometer range or a combined structure in the nano- and micrometer ranges.

2. Method according to claim 1, wherein the hydrophilic surface components are silanol, carbinol or metal hydroxide groups.

3. Method according to claim 1, wherein a structure is formed in the nanometer range with a size from 5 to 150 nm, preferably from 5 to 80 nm.

4. Method according to claim 1, wherein a structure is formed in the micrometer range with a size from 0.2 to 50 μm, preferably from 1 to 10 μm.

5. Method according to claim 1, wherein the coating contains structure-imparting nanoparticles.

6. Method according to claim 5, wherein the nanoparticles are silicon dioxide particles or titanium dioxide particles.

7. Method according to claim 5, wherein the coating contains nanoparticles of silver or silver oxide.

8. Method according to claim 1, wherein a coating material is applied on top of a paint or coating that is not yet entirely dry.

9. Method according to claim 8, wherein coatings are applied to substrates of glass, ceramics, glass ceramics, stone, concrete, plaster, natural stone, wood, fabric, textile materials, leather, artificial leather, plastics, metals, metalloids and substrates with coated surfaces.
